(19) United States
(12) Patent Application Publication
(10) Pub. No.: US 2015/0103651 A1
(43) Pub. Date: Apr. 16, 2015

(54) METHOD FOR MANAGING DEVICE BEHAVIOR DURING INCREASED LOAD OR CONGESTION USING POLICIES

(71) Applicant: Sami Johannes Kekki, Helsinki (FI)

(72) Inventor: Sami Johannes Kekki, Helsinki (FI)

(73) Assignee: Nokia Corporaiton

(21) Appl. No.: 14/401,060

(22) PCT Filed: May 14, 2012
(86) PCT No.: PCT/IB2012/052407

§ 371 Date: Nov. 13, 2014

(51) Int. Cl. H04W 28/02

(52) U.S. Cl. CPC H04W 28/0289
USPC 370/230

(57) ABSTRACT

An apparatus for enabling provision of one or more policies to manage behavior of one or more communications devices may include a processor and memory storing executable computer code causing the apparatus to at least perform operations including analyzing data of at least one policy. The policy includes information instructing a communication device(s) regarding a manner to behave according to a designated network condition(s) designated by a network operator. The computer program code may further cause the apparatus to apply the policy responsive to detecting a load of a network is increased or that the network is congested. The computer program code may further cause the apparatus to behave in the manner designated by the network operator according to the applied policy responsive to detecting the increased load or that the network is congested to minimize congestion in the network. Corresponding methods and computer program products are also provided.

### TECHNOLOGICAL FIELD

An example embodiment of the invention relates generally to wireless communication technology and more particularly, relates to a method, apparatus, and computer program product for enabling provision of one or more policies to manage traffic in communications systems.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to management of traffic in networks.

Due to the exponential growth of the wireless data use, the industry has started to develop mechanisms for better managing the growth of traffic in networks. Part of the development efforts are aimed at making the use of existing assets more efficient, thus allowing better return on investments. At present, many mobile network operators are increasingly planning the manner in which to use their cellular network assets and other complementary wireless network assets most efficiently to maximize the use of network assets and minimize costs.

Currently, many mobile operators may have a multitude of wireless access networks available in different geographical locations. The manner in which to utilize the wireless network assets is typically part of a mobile operator's overall strategy for using their resources efficiently while at the same time offering the expected quality of service for their customers, the end users. An existing challenge typically involves making the end user devices behave in a deterministic way that also follows the mobile operator's strategy for wireless network use.

At present, when the wireless network gets congested, the devices of end users typically experience a degradation of service. The devices may attempt to request access to the network to get new bearers established or bearer bit rates increased for new demand. However, due to increased load in the network, the network generally does not accept such requests, but instead rejects the requests. In other words, the network may reject requests that may not be accommodated when congestion gets severe and the network may begin barring some devices from accessing the network. As a drawback, the end users of the devices may become disappointed in the low quality of experience that results from the manner in which the congested network behaves.

In view of the foregoing drawbacks, it may be beneficial to provide a more efficient and reliable mechanism of enabling management of congestion in one or more wireless networks.

### BRIEF SUMMARY

A method, apparatus and computer program product are therefore provided for enabling provision of policies to efficiently manage congestion in communications systems. In this regard, an example embodiment may provide a framework that enables provision of a new and complementary approach to managing the congestion in a wireless network(s). The wireless network(s) may provide cellular access and/or non-cellular access (e.g., Wireless Local Area Network), or any other suitable network access. In this regard, an example embodiment may allow network operators (e.g., mobile network operators) to implement a strategy of using available wireless technologies in their portfolio. In an example embodiment, a network device of a network operator may provide a set of instructions (e.g., policy instructions) to one or more communication devices in the network. These instructions may guide the behavior of the communication devices under one or more defined special conditions including but not limited to, for example, an instance in which an increased load or congestion is detected in the network.

By utilizing one or more policies of a network operator, one or more communication devices may proactively adapt to congestion and any other special circumstances for which a network operator(s) has a policy in place, thus making network resources better for usage and minimizing end user irritation associated with blocking access to the network and/or services of the network as well as collapsing quality of service (QoS) in the network.

In this regard, a network operator may expect more deterministic and compliant behavior from the communication devices by enabling the communication devices to follow the planned strategy of a network operator(s) for any special circumstances. As such, an end user of a communication device(s) may achieve a better service experience in an instance in which actual service rejections and access barring by the network are avoided. In an example embodiment, an end user of a communication device(s) may achieve a better service experience in an instance in which the communication device(s) notifies the end user of the network congestion. By more efficiently handling traffic or congestion, an example embodiment may enable a number of active communication devices in a network to increase.

In one example embodiment, a method for enabling provision of one or more policies to manage behavior of one or more communications devices is provided. The method may include analyzing data of at least one policy. The data of the policy includes information instructing one or more communication devices regarding a manner in which to behave according to one or more designated network conditions as designated by a network operator. The method may further include applying the policy in response to detecting that a load of a network is increased or that the network is congested. The method may further include enabling behavior in the manner designated by the network operator according to the applied policy in response to detecting the increased load or that the network is congested to minimize a congestion in the network.

In another example embodiment, an apparatus for enabling provision of one or more policies to manage behavior of one or more communications devices is provided. The apparatus may include a processor and a memory including computer program code. The memory and the computer program code are configured to, with the processor, cause the apparatus to perform operations including analyzing data of at least one policy. The data of the policy includes information instructing one or more communication devices regarding a manner in which to behave according to one or more designated network conditions as designated by a network operator. The memory and computer program code are further configured to, with the processor, cause the apparatus to apply the policy in response to detecting that a load of a network is increased or that the network is congested. The memory and computer program code are further configured to, with the processor, cause the apparatus to enable behavior in the manner designated by the network operator according to the applied policy in response to detecting the increased load or that the network is congested to minimize a congestion in the network.

In another example embodiment, a computer program product for enabling provision of one or more policies to manage behavior of one or more communications devices is provided. The computer program product includes at least one computer-readable storage medium having computer executable program code instructions stored therein. The computer executable program code instructions may include program code instructions configured to analyze data of at least one policy. The data of the policy includes information instructing one or more communication devices regarding a manner in which to behave according to one or more designated network conditions as designated by a network operator. The program code instructions may also be configured to apply the policy in response to detecting that a load of a network is increased or that the network is congested. The program code instructions may also be configured to enable behavior in the manner designated by the network operator according to the applied policy in response to detecting the increased load or that the network is congested to minimize a congestion in the network.

In yet another example embodiment, a method for enabling provision of one or more policies to manage behavior of one or more communications devices is provided. The method may include enabling provision of at least one policy to a communication device to enable the communication device to analyze data of the policy. The data of the policy includes information instructing the communication device regarding a manner in which to behave according to one or more designated network conditions as designated by a network operator of the apparatus. The method may further include enabling provision of information to the communication device indicating an increased load or that the network is congested to enable the communication device to apply the policy in response to analyzing the information and detecting that the load of the network is increased or that the network is congested. Enabling provision of the information to the communication device also enables the communication device to behave in the manner designated by the network operator according to the applied policy to minimize a congestion in the network.

In yet another example embodiment, an apparatus for enabling provision of one or more policies to manage behavior of one or more communications devices is provided. The apparatus may include a processor and a memory including computer program code. The memory and the computer program code are configured to, with the processor, cause the apparatus to perform operations including enabling provision of at least one policy to a communication device to enable the communication device to analyze data of the policy. The data of the policy includes information instructing the communication device regarding a manner in which to behave according to one or more designated network conditions as designated by a network operator of the apparatus. The memory and computer program code are further configured to, with the processor, cause the apparatus to enable provision of information to the communication device indicating an increased load or that the network is congested to enable the communication device to apply the policy in response to analyzing the information and detecting that the load of the network is increased or that the network is congested. Enabling provision of the information to the communication device also enables the communication device to behave in the manner designated by the network operator according to the applied policy to minimize a congestion in the network.

In yet another example embodiment, a computer program product for enabling provision of one or more policies to manage behavior of one or more communications devices is provided. The computer program product includes at least one computer-readable storage medium having computer executable program code instructions stored therein. The computer executable program code instructions may include program code instructions configured to enable provision of at least one policy to a communication device to enable the communication device to analyze data of the policy. The data of the policy includes information instructing the communication device regarding a manner in which to behave according to one or more designated network conditions as designated by a network operator of the apparatus. The program code instructions may also be configured to enable provision of information to the communication device indicating an increased load or that the network is congested to enable the communication device to apply the policy in response to analyzing the information and detecting that the load of the network is increased or that the network is congested. Enabling provision of the information to the communication device also enables the communication device to behave in the manner designated by the network operator according to the applied policy to minimize a congestion in the network.

An example embodiment of the invention may provide a better user experience by providing a framework that may efficiently manage congestion in a wireless network(s). As a result, device users may enjoy improved capabilities with accessing wireless networks in loaded conditions.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a block diagram of a system according to an example embodiment of the invention;

FIG. 5 illustrates a flowchart for enabling provision of a policy to manage the congestion in a network according to an example embodiment;

FIG. 6 illustrates a flowchart for enabling provision of a policy to manage congestion in a network according to another example embodiment of the invention; and

FIG. 7 illustrates a flowchart for enabling provision of a policy to manage congestion in a network according to another example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

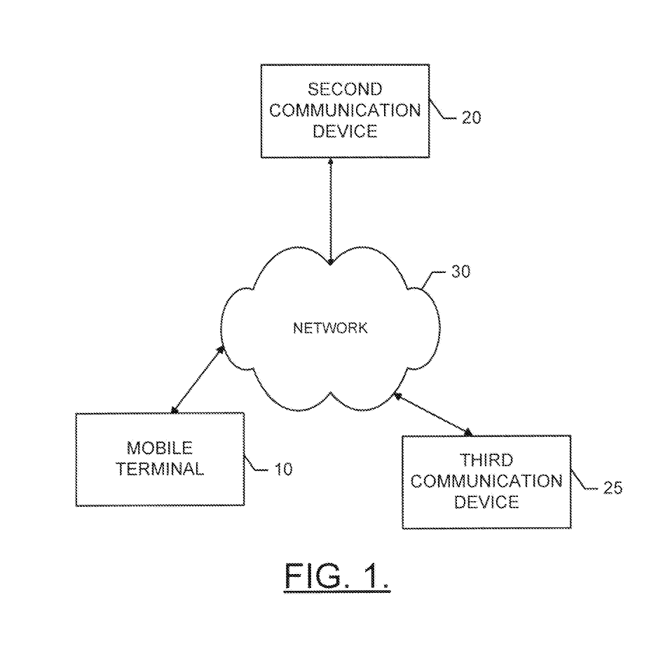

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network, Global System for Mobile Communications (GSM) Enhanced Data for GSM Evolution (EDGE) Radio Access Network (GERAN), High Speed Packet Access (HSPA) and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like. In this regard, the network 30 may enable communications via devices such as, for example, 3rd Generation Partnership Project (3GPP) defined cellular technologies (e.g., GERAN, UTRAN, E-UTRAN, HSPA, LTE, WLAN, etc.) and other non-3GPP wireless technologies (e.g., WiMAX, CDMA, etc.).

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

In an example embodiment, the second communication device 20 may be a dedicated server (or server bank) associated with a particular information source or service (e.g., a search service, a media provision service, etc.) or the second communication device 20 may be a backend server (e.g., a policy server) associated with one or more other functions or services. For example, in one example embodiment, the second communication device 20 may provide one or more policies to the mobile terminal 10 and/or third communication device 25. The policies may be utilized by the mobile terminal 10 and/or third communication device 25 to manage congestion in the network (e.g., network 30) or any other suitable conditions (e.g., network conditions). As such, the second communication device 20 may represent a potential host for a plurality of different services or information sources. In one embodiment, the functionality of the second communication device 20 is provided by hardware and/or software components configured to operate in accordance with known techniques for the provision of information to users of communication devices. However, at least some of the functionality provided by the second communication device is information provided in accordance with an example embodiment of the invention.

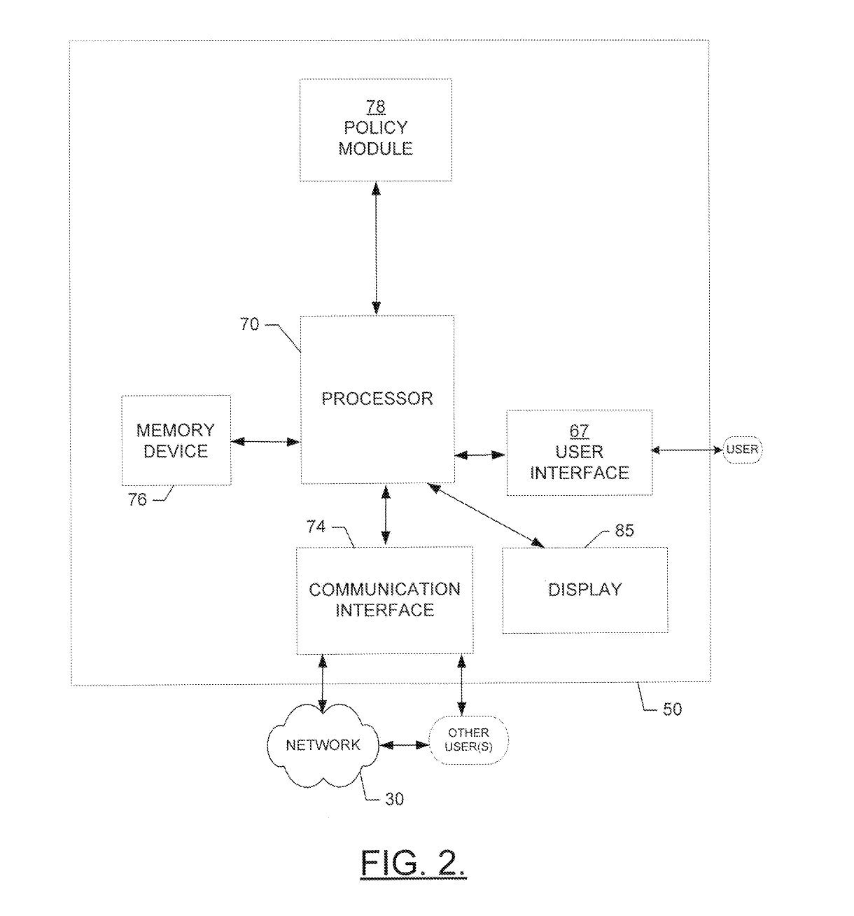

In an example embodiment, the mobile terminal 10 as well as the second and third communication devices 20 and 25 may employ an apparatus (e.g., apparatus of FIG. 2) capable of employing an embodiment of the invention.

FIG. 2 illustrates a schematic block diagram of an apparatus for utilizing one or more policies to manage behavior of the apparatus. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, and a policy module 78. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, policies, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.).

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, and/or a coprocessor or the like may execute a browser, Web browser or the like. In this regard, the connectivity program may enable the apparatus 50 to transmit and receive Web content, such as for example location-based content or any other suitable content, according to a Wireless Application Protocol (WAP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the policy module. The policy module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the policy module 78, as described below. Thus, in an example in which software is employed, a device or circuitry (e.g., the processor 70 in one example) executing the software forms the structure associated with such means.

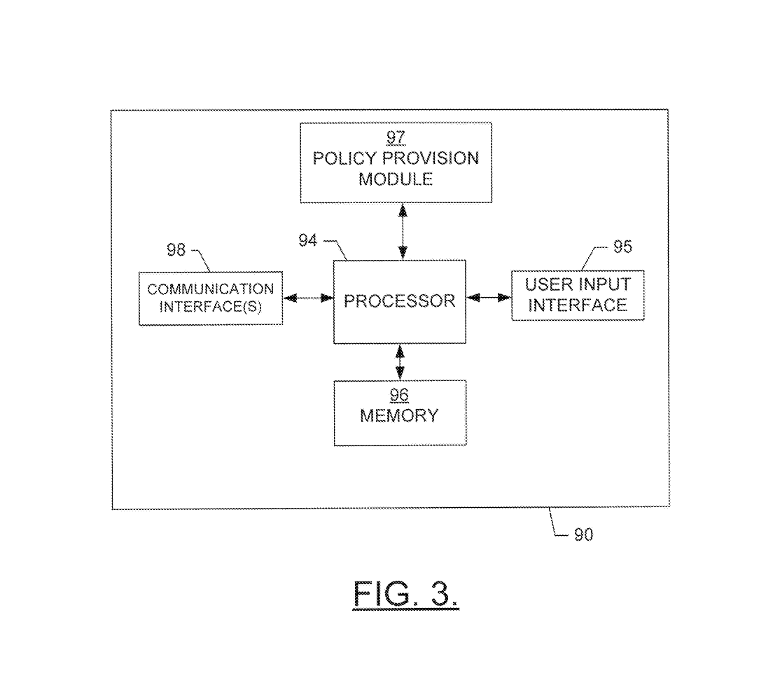

The policy module 78 may receive one or more policies (e.g., instructions) from a network device (e.g., network device 90 of FIG. 3). Additionally or alternatively, the policy module 78 may access one or more policies that may be pre-provisioned on the apparatus 50. The pre-provisioned policies may be stored in a memory (e.g., memory device 76) of the apparatus 50.

The one or more policies may provide instructions from the network device of a network operator for managing the congestion in the wireless network(s) or a communications system. In this regard, for example, these policy module 78 may utilize the instructions to guide the behavior of the apparatus under any defined special conditions including, but not limited to for example, an instance in which an increased load or congestion is detected in the network (e.g., network 30), as described more fully below.

The manner in which the policy module 78 may detect a condition to trigger the start of applying/implementing the one or more policies may be specific to a given network(s) or communications system(s). As such, the policy module 78 may analyze information of one or more policies to detect the condition (e.g., congestion, an increased load, etc.) and began applying/implementing the one or more policies. Although, network congestion is described herein as an exemplary non-limiting embodiment as a condition or circumstance that is managed by one or more policies other similar policies may be defined and utilized for other conditions (e.g., special or abnormal conditions) without departing from the spirit and scope of the invention. Such other conditions may include scenarios in which the network has initiated access barring for some or all device or subscriber categories, for example, due to some network maintenance or network equipment failure reasons and thus the availability of the communication services gets temporarily reduced. Yet another example of conditions where similar policies may be applied is related to reaching a pre-defined number of users attached to a particular access point or radio cell, even if no congestion or increase in the traffic load had yet appeared or been detected. In this latter example, the application of the specific policy may be a preventive mechanism to avoid any future congestion in the first place.

Referring now to FIG. 3, a block diagram of one example of a network device is provided. In an example embodiment, the network device 90 (e.g., a server (e.g., a policy server)) may provide one or more policies to apparatuses (e.g., apparatuses 50). The instructions of the one or more policies may guide the behavior of the apparatuses according to one or more defined or designated conditions including, but not limited to, for example, an increased load or congestion detected in a network(s) or communications system(s).

As shown in FIG. 3, the network device (e.g., a second communication device 20) generally includes a processor 94 and an associated memory 96. The memory 96 may comprise volatile and/or non-volatile memory, and may store content (e.g., one or more policies), data and/or the like. For example, the memory may store content, data, information, and/or the like transmitted from, and/or received by, the network device. Also for example, the memory 96 may store client applications, instructions, and/or the like for the processor 94 to perform the various operations of the network device in accordance with an embodiment of the invention, as described herein.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network device to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The network device 90 may, in one embodiment, be a computing device configured to employ an example embodiment of the invention. However, in one embodiment, the network device 90 may be embodied as a chip or chip set. In this regard, the network device 90 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The network device 90 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 94 may be embodied in a variety of different ways. For example, the processor 94 may be embodied as one or more of various processing means such as a coprocessor, microprocessor, a controller, a DSP, processing circuitry with or without an accompanying DSP, or various other processing devices including integrated circuits such as, for example, an ASIC, an FPGA, a microcontroller unit, a hardware accelerator, a special-purpose computer chip, or the like. In an example embodiment, the processor 94 may be configured to execute instructions stored in the memory 96 or otherwise accessible to the processor 94. As such, whether configured by hardware or software methods, or by a combination thereof, the processor 94 may represent an entity (e.g., physically embodied in circuitry) capable of performing operations according to an embodiment of the invention while configured accordingly. Thus, for example, when the processor 94 is embodied as an ASIC, FPGA or the like, the processor 94 may be specifically configured hardware for conducting the operations described herein. Alternatively, as another example, when the processor 94 is embodied as an executor of software instructions, the instructions may specifically configure the processor 94 to perform the algorithms and operations described herein when the instructions are executed.

In an example embodiment, the processor 94 may be embodied as, include or otherwise control a policy provision module 97. The policy provision module 97 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the policy provision module 97, as described below. Thus, in an example in which software is employed, a device or circuitry (e.g., the processor 94 in one example) executing the software forms the structure associated with such means.

The policy provision module 97 may generate one or more policies. In this regard, the policy provision module 97 may facilitate storage (e.g., in memory 96) of “operator policies” in a network. In this regard, the policy provision module 97 may be a repository for the policies that include the criteria for such conditions (e.g., congestion conditions). The criteria may be considered as validity conditions for the given policy. Once the policies have been provided (e.g., downloaded (e.g., pushed)) or pre-provisioned (e.g., the policies may be in the apparatus 50 when the apparatus 50 is purchased from a store of a network operator) to the apparatus 50 (e.g., the policy module 78 of the apparatus 50) or alternatively once the apparatus 50 has fetched (e.g., pulled) the policies from apparatus 90, the policy module 78 of the apparatus 50 may detect any such conditions that match with the validity conditions of the policies in the network. For purposes of illustration and not of limitation, in an instance in which a condition corresponds to congestion, the policy module 78 may determine an instance in which a network is congested with traffic or has an increased load. For instance, the policy module 78 may determine that a network(s) (e.g., network 30) or communications system(s) is congested or has an increased load (e.g., is overloaded) in response to detecting that a number of apparatuses (e.g., apparatuses 50) being utilized in the network(s) or communications system(s) is above a predetermined threshold, for example.

The generated policies may include data instructing one or more of the apparatuses (e.g., apparatuses 50) of the manner in which to behave while the network is experiencing congestion or an increased load. In an example embodiment, a policy may also include the defined criteria for congestion for the apparatus 50 to then use the defined criteria for determining whether the network is in a state or condition covered by the given policy. The apparatus 50 may use the defined criteria for determining whether the network is in a state or condition covered by the given policy in an instance in which the validity conditions for the policy are fulfilled. In this regard, the policy provision module 97 may provide the one or more policies to one or more of the apparatuses (e.g., apparatuses 50) of the network. In response to receipt of the one or more policies, the policy module (e.g., policy module 78) of the respective apparatuses (e.g., apparatuses 50) may analyze the information (e.g., instructions) of the one or more policies to adapt their behavior in response to the congestion in a planned manner as specified/designated by the one or more policies, as described more fully below.

In an example embodiment, the policy provision module 97 may provide/deliver the one or more policies to the one or more apparatuses (e.g., apparatuses 50) based in part, for example, on using an Open Mobile Alliance (OMA) Device Management framework utilized in cellular and non-cellular systems and/or by using a Simple Object Access Protocol (SOAP)/Extensible Markup Language (XML) protocol available in some Institute of Electrical and Electronics Engineers (IEEE) defined access networks. Additionally or alternatively, the policy provision module 97 may send one or more generated policies to one or more apparatuses (e.g., apparatuses 50) or by utilizing one or more Short Message Service (SMS) messages or any other suitable messages.

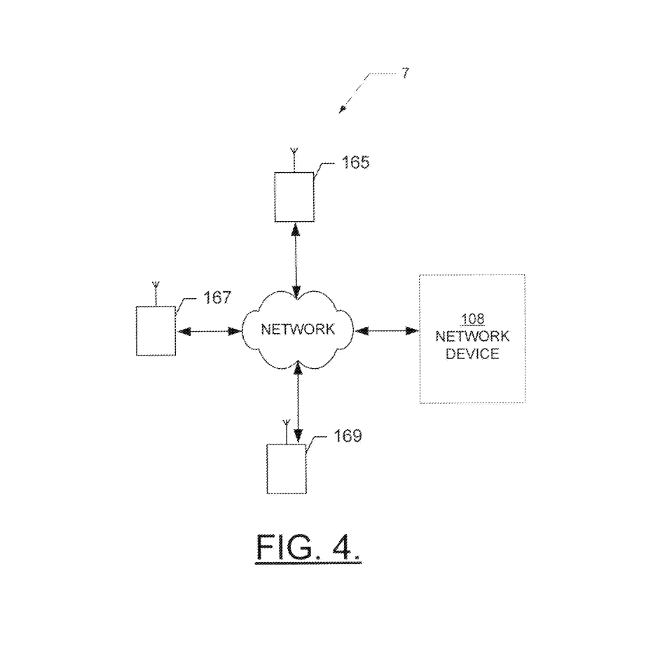

Referring now to FIG. 4, an example embodiment is provided of a communications system for enabling provision of one or more policies to manage behavior of one or more communications devices. The communications system 7 may include communication devices 165, 167, 169 (e.g., apparatuses 50 (e.g., mobile terminals 10)) as well as a network device 108 (e.g., network device 90).

Although FIG. 4 shows three communication devices 165, 167 and 169, and one network device 108, it should be pointed out that the communications system 7 of FIG. 4 may include any suitable number of communication devices 165, 167, 169 and network devices 108 without departing from the spirit and scope of the invention.

In an example embodiment, the network device 108 (e.g., network device 90) may generate one or more policies and may provide the one or more policies to one or more of the communication devices 165, 167 and/or 169. In one example embodiment, the policy provision module (e.g., policy provision module 97) of the network device 108 may generate and send the one or more policies to one or more of the communication devices 165, 167 and/or 169 in response to determining that the communications system 7 is congested or has an increased load (e.g., the communications system 7 is overloaded). Alternatively, the policy provision module of the network device 108 may send the one or more policies to one or more of the communication devices 165, 167, 169 even in an instance in which the communications system 7 is not currently congested or overloaded. In this regard, the instructions of the one or more policies may specify to the communication devices 165, 167, 169 the manner in which to behave in an instance in which the policy provision module of the network device 108 and/or the policy module (e.g., policy module 78) of the communication devices 165, 167, 169 subsequently determine that the communications system 7 is congested or has an increased load.

In an example embodiment, a trigger for the policy module (e.g., policy module 78) of one or more of the communication devices 165, 167, 169 to apply/implement a policy (e.g., a congestion policy) may include but is not limited to the following approaches: (1) detection, by the policy module, of access class barring in a corresponding serving cell or access point of the communications system 7 or in one or more neighboring cells or access points of the communications system 7; (2) detection, by the policy module, of one or more signals sent by the network device 108 indicating additional back-off time for any resource requests either on a Radio Resource Control (RRC) level or on a Non-Access Stratum (NAS) level; (3) detection, by the policy module, that the network device 108 broadcasts a load level or congestion level on the RRC level or on the NAS level matching or exceeding the criteria for applying the policy; (4) detection, by the policy module (e.g., policy module 78), that the network device broadcasts the number of current communications devices (e.g., apparatuses 50) utilizing a cell (e.g., a serving cell) or access point and indicating that number is above a predetermined threshold value or policy criteria; (5) detection, by the policy module, of an increase in the experienced round trip times on the communication path used by the device (e.g., apparatus 50) for communication with a server in the network. The server may be, for example, an Instant Messaging or Social Media server hosted by the mobile network operator or any other suitable server. The communication may take place, for example, over a Transport Control Protocol (TCP) connection; (6) detection, by the policy module, that the network (e.g., network device 108, etc.) explicitly instructs the corresponding communication device(s) (e.g., communication device 165, 167, 169) to start applying/implementing the policy for the given condition (e.g., congestion, increased load, etc.); or (7) any other suitable approaches/techniques.

In an example embodiment, in an instance in which one or more of the communication devices 165, 167, 169 communicate in a device-to-device fashion (e.g., a P2P technique), a communication device (e.g., communication device 165) may learn about the condition in the network from another communication device (e.g., communication device 167) in close vicinity/proximity.

In contrast to the existing conventional mechanism for reducing the congestion in a network based on the network starting to reactively reject new resource requests and completely blocking a communication device to access (e.g., in case of barring) the network, this new approach of an example makes a communication device adapt its behavior to the congestion in a network operator planned manner. By enabling a communication device (e.g., communication device 165) to adapt its behavior to congestion in a network based in part on a policy (e.g., a congestion policy), the communication device may implement the network operator's (e.g., a mobile network operator) strategy for more efficient use of available resources of the network. As such, the behavior of communication devices of the network may become more predictable and more compliant regarding the manner in which the communication devices behave in an instance in which the network load is increased or when congestion occurs.

In an example embodiment, in an instance in which a communication device (e.g., communication device 165) starts following any policy (e.g., a congestion policy) intended for a congestion situation, the policy module of the communication device may also inform the user of the communication device of the implementation of the policy. By informing, for example, via the display 85, the user of the implementation of the policy, the user is made aware that the communication device (e.g., communication device 165) is currently operating under specific instructions that are being utilized by the policy module (e.g., policy module 78) to reduce the impact of the overall congestion of the network. In an example embodiment, the policy module may inform the user that a policy is being implementing by providing visible indicia to a display (e.g., display 85) indicating that the policy is being implemented. The user may then utilize a user interface (e.g., user interface 67) to make a selection to overrule any such congestion policy which may discontinue the applied policy and accept the potential that the network service may degrade further or may be completely rejected if the user does not allow the policy module of the communication device (e.g., communication device 165) to follow the policy. Alternatively, the user may allow the communication device to behave in the manner specified by the policy and thus may expect a better overall communications experience. The user may allow the communication device to behave in the manner specified by the policy by not making a selection to overrule the policy (e.g., congestion policy).

The applied policy (e.g., congestion policy) may have an impact on the manner in which a communication device (e.g., communication device 165) responds to any user requests for new services or to any requests from one or more applications. The policy (e.g., congestion policy) may also be utilized by the policy module (e.g., policy module 78) to trigger a communication device (e.g., communication device 165) to start scanning for availability of an alternative access (e.g., access to a neighbor cell or access point) to a network or to start using an available alternative access to the network for all or at least a subset of the active communication of the communication device. By analyzing the congestion policy, the policy module may also begin restricting any guaranteed bit rate requests for bearers or flows which may result in the policy module downgrading the quality of service (QoS) request, for example, from guaranteed to best effort.

In an example embodiment, in an instance in which the policy module analyzes data of the policy, the policy module may also result in selecting a lower bit rate coding scheme for applications that may utilize adaptive coding. Alternatively, the policy module (e.g., policy module 78) of a communication device (e.g., communication device 165) may select a more efficient modulation and coding schema on a radio for the bearers. In an example embodiment, the policy module of a communication device may notify an application(s) or the user of any such QoS resource manipulations. For example, the policy module may notify the application(s) of any QoS resource manipulations by sending one or more instructions to the application(s) informing the application of a QoS resource manipulation(s). Additionally, for example, the policy module may notify the user of any QoS resource manipulations by providing visible indicia to a display (e.g., display 85) indicating the QoS resource manipulation(s).

The use of one or more policies by the policy module of a communication device may be based in part on the communication device (e.g., communication device 165) receiving information, either directly or indirectly, of the level of load and/or congestion in a network(s) or communications system(s). In an example embodiment, the network device 108 may provide one or more communication devices (e.g., communication devices 165, 167, 169) indications of congestion or increased load of a network or communications system (e.g., communications system 7) in an instance in which the policy provision module of the network device 108 detects that the number of communications devices in the network(s) or communications system(s) exceeds a predetermined threshold value. Detection, by the policy module, of a communication device of the congestion (e.g., excess traffic) or increase in a load of a network(s) or a communications system(s), may trigger the communication device to behave according to the information (e.g., instructions) of one or more corresponding policies. In one example embodiment, the policy provision module (e.g., policy provision module 97) of a network device (e.g., network device 108) may generate one or more different policies for one or more different levels of congestion. The different policies corresponding to the different levels of congestion may be generated based in part on the accuracy in which a network operator of network(s) or a communications system(s) (e.g., communications system 7) desires to control the behavior of one or more communication devices (e.g., communication devices 165, 167, 169).

The policy provision module (e.g., policy provision module 97) of a network device (e.g., network device 108) may also generate one or more separate, or common, policies for different types of access networks or for specific access networks identified by their name or an identifier (e.g., a Public Land Mobile Network (PLMN) identifier (ID) (PLMN-ID), a Cell ID, a Service Set Identification (SSID), a Homogenous Extended Service Set ID (HESSID), etc.)

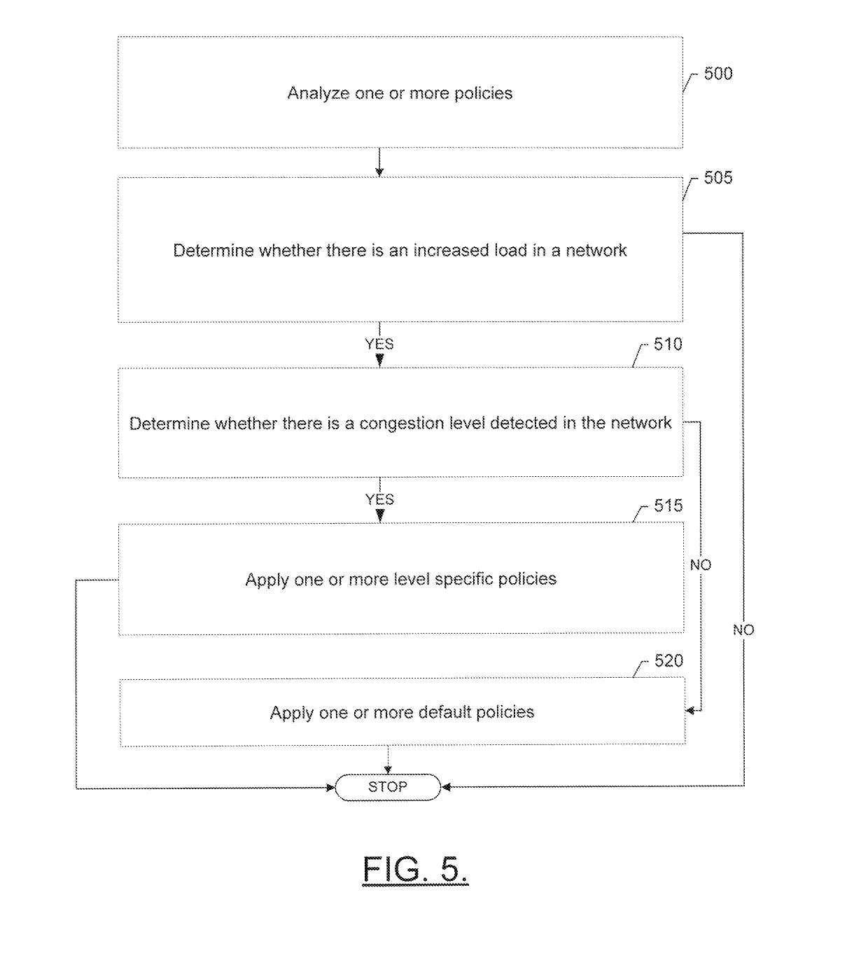

Referring now to FIG. 5, a flowchart of an example method for enabling provision of one or more policies to manage behavior of one or more communications devices is provided. At operation 500, an apparatus (e.g., apparatus 50) may include means, such as the policy module 78, the processor 70 and/or the like for analyzing one or more policies. The policies may be generated by the policy provision module 97 of a network device (e.g., network device 90) or may be pre-provisioned on the apparatus and stored in a memory (e.g., memory device 76) of the apparatus (e.g., apparatus 50). In one example embodiment, the policy provision module 97 may generate the policies or may store the policies and then distribute the policies to the communication devices. In this regard, the policy provision module 97 may be a repository and the distributor for the policies that a network operator (e.g., a mobile operator) has created. At operation 505, an apparatus (e.g., apparatus 50) may include means, such as the policy module 78, the processor 70 and/or the like for determining whether there is an increased load in a network. In an instance in which the policy module 78 and/or the processor 70 determine that there is not any increased load in the network, the process ends. At operation 510, an apparatus (e.g., apparatus 50) may include means such as the policy module 78, the processor 70, the communication interface 74 and/or the like for determining whether a congestion level is detected in response to determining that there is an increased load in the network. The policy module 78 and/or processor 70 may determine that there is an increase in a load of a network and that a congestion level is detected based in part on analyzing data provided by a network device (e.g., network device 90) of a network. As one example, the policy provision module 97 of the network device may determine that a congestion level is detected in an instance in which the policy provision module 97 determines that a number of apparatuses communicating or being serviced in the network exceeds a predetermined threshold value.

At operation 515, an apparatus (e.g., apparatus 50) may include means, such as the policy module 78, the processor 70 and/or the like for applying/implementing one or more specific policies (e.g., congestion level specific policies) in response to determining that a certain congestion level of a network is detected. In case the congestion gets worse, yet another congestion level specific policy may become applicable. At operation 520, an apparatus (e.g., apparatus 50) may include means, such as the policy module 78, the processor 70 and/or the like for applying/implementing one or more default policies for any abnormal scenarios such as congestion (e.g., congestion policies) in response to determining that a network is congested. In an example embodiment, a default policy may be a policy that is a more generic policy for a device (e.g., apparatus 50) to follow in case of congestion or in case of any abnormal circumstance in the network, when there are no more specific policies to apply in the given situation.

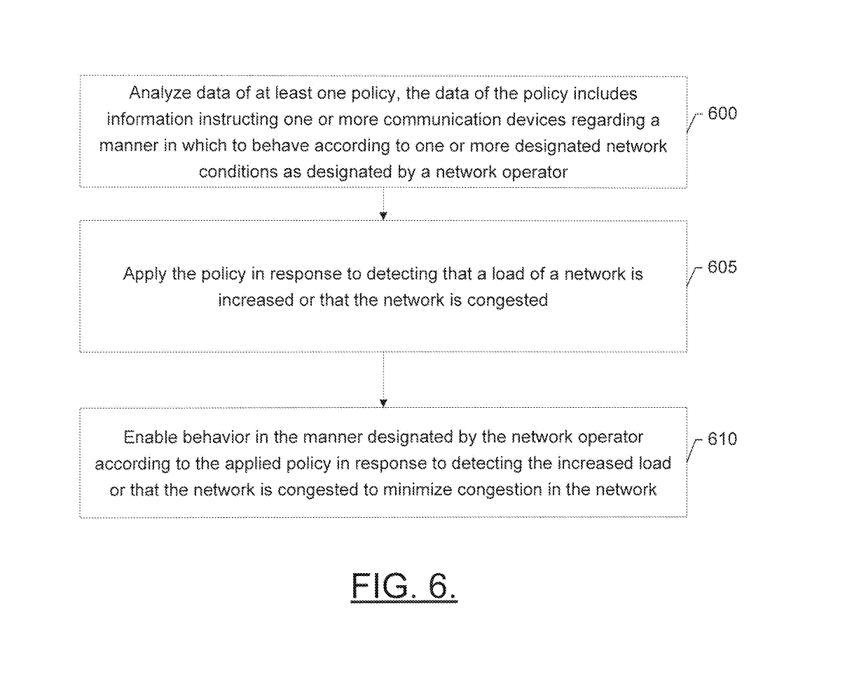

Referring now to FIG. 6, a flowchart of another example method for enabling provision of one or more policies to manage behavior of one or more communications devices is provided. At operation 600, an apparatus (e.g., apparatus 50) may include means, such as the policy module 78, the processor 70 and/or the like for analyzing data of at least one policy. The data of the policy may include information instructing one or more communication devices regarding a manner in which to behave according to one or more designated network conditions (e.g., network congestion) as specified or designated by a network operator. At operation 605, the apparatus (e.g., apparatus 50) may include means, such as the policy module 78, the processor 70 and/or the like for applying/implementing the policy (e.g., a congestion policy) in response to detecting that a load of a network is increased or that the network is congested. At operation 610, the apparatus (e.g., apparatus 50) may include means, such as the policy module 78, the processor 70 and/or the like for enabling behavior in the manner designated by the network operator according to the applied/implemented policy in response to detecting the increased load or that the network is congested to minimize congestion in the network. By applying the policy, the policy module (e.g., policy module 78) may enable acceptance of one or more requests to a network device (e.g., network device 90) of the network to access the network even though the network detected as being congested.

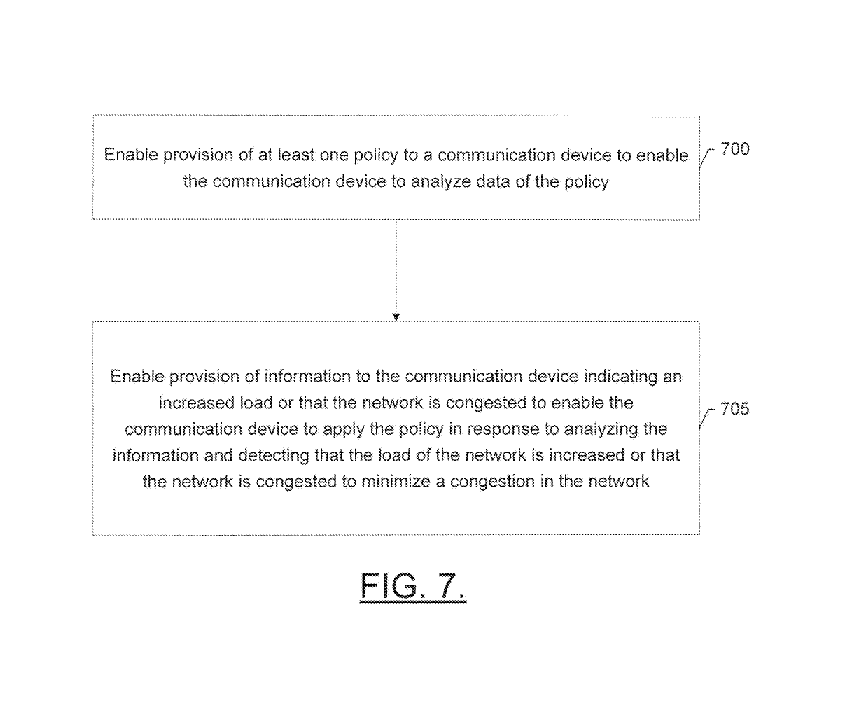

Referring now to FIG. 7, a flowchart of another example method for enabling provision of one or more policies to manage behavior of one or more communications devices is provided. At operation 700, an apparatus (e.g., network device 90) may include means, such as the policy provision module 97, the processor 94 and/or the like for enabling provision of at least one policy to a communication device (e.g., apparatus 50) to enable the communication device to analyze data of the policy. The data of the policy may include information instructing the communication device regarding a manner in which to behave according to one or more designated network conditions (e.g., network congestion) as designated by a network operator of the apparatus (e.g., network device 90).

At operation 705, the apparatus (e.g., network device 90) may include means, such as the policy provision module 97, the processor 94 and/or the like for enabling provision of information to the communication device (e.g., apparatus 50) indicating an increased load or that the network is congested to enable the communication device to apply/implement the policy in response to analyzing the information and detecting that the load of the network is increased or that the network is congested. The provision of the information to the communication device (e.g., apparatus 50), by the apparatus (e.g., network device 90), may also enable the communication device to behave in the manner designated or specified by the network operator according to the applied policy to minimize congestion in the network. In an instance in which the communication device applies the policy, the policy provision module of the apparatus (e.g., network device 90) may allow access to the network or one or more resources of the network in response to receipt of one or more requests from the communication device even though the network may be identified as being congested.

It should be pointed out that FIGS. 5, 6 and 7 are flowcharts of systems, methods and computer program products according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94, policy module 78, policy provision module 97). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5, 6 and 7 above may comprise a processor (e.g., the processor 70, the processor 94, the policy module 78, the policy provision module 97) configured to perform some or each of the operations (500-520, 600-610, 700-705) described above. The processor may, for example, be configured to perform the operations (500-520, 600-610, 700-705) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (500-520, 600-610, 700-705) may comprise, for example, the processor 70 (e.g., as means for performing any of the operations described above), the processor 94, the policy module 78, the policy provision module 97 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-35. (canceled)

36. A method comprising:
analyzing data of at least one policy, the data of the policy comprising information instructing one or more communication devices regarding a manner in which to behave according to one or more designated network conditions as designated by a network operator;
applying the policy in response to detecting that a load of a network is increased or that the network is congested; and
enabling behavior in the manner designated by the network operator according to the applied policy in response to detecting the increased load or that the network is congested to minimize a congestion in the network.

37. The method of claim 36, wherein detecting comprises receiving content from a network device of the network operator indicating the increased load in the network or that the network is congested.

38. The method of claim 37, wherein detecting that the network is congested comprises determining that the content indicates that a plurality of communication devices are communicating in the network exceeds a predetermined threshold value.

39. The method of claim 36, wherein detecting the increased load or that the network is congested comprises detecting barring or blocking of access to a cell of the network or one or more neighbor cells of the network.

40. The method of claim 36, wherein detecting the increased load or that the network is congested comprises detecting one or more received signals from the network device indicating an additional back-off time in response to at least one request for one or more resources.

41. The method of claim 36, further comprising:
selecting a lower bit rate coding scheme corresponding to one or more applications utilizing adaptive coding in response to the applying of the policy.

42. An apparatus comprising:
at least one processor; and
at least one memory including computer program code configured to, with the at least one processor, cause the apparatus to perform at least the following:
analyze data of at least one policy, the data of the policy comprising information instructing one or more communication devices regarding a manner in which to behave according to one or more designated network conditions as designated by a network operator;
apply the policy in response to detecting that a load of a network is increased or that the network is congested; and
enable behavior in the manner designated by the network operator according to the applied policy in response to detecting the increased load or that the network is congested to minimize a congestion in the network.

43. The apparatus of claim 42, wherein the memory and computer program code are configured to, with the processor, cause the apparatus to:
detect the increased load or that the network is congested by receiving content from a network device of the network operator indicating the increased load in the network or that the network is congested.

44. The apparatus of claim 43, wherein the memory and computer program code are configured to, with the processor, cause the apparatus to:
detect that the network is congested by determining that the content indicates that a plurality of communication devices communicating in the network exceeds a predetermined threshold value.

45. The apparatus of claim 43, wherein the memory and computer program code are configured to, with the processor, cause the apparatus to:
receive the content by receiving the content from the network device on a Radio Resource Control or a Non-Access Stratum level.

46. The apparatus of claim 42, wherein the memory and computer program code are configured to, with the processor, cause the apparatus to:
detect the increased load or that the network is congested by detecting barring or blocking of access to a cell of the network or one or more neighbor cells of the network.

47. The apparatus of claim 42, wherein the memory and computer program code are configured to, with the processor, cause the apparatus to:
detect the increased load or that the network is congested by detecting one or more received signals from the network device indicating an additional back-off time in response to at least one request for one or more resources.

48. The apparatus of claim 42, wherein prior to analyze the data of the policy, the memory and computer program code are configured to, with the processor, cause the apparatus to:
receive the at least one policy from the network device of the operator.

49. The apparatus of claim 42, wherein the memory and computer program code are configured to, with the processor, cause the apparatus to:
enable provision of visible indicia to a display to indicate to a user that instructions are being implemented to reduce the impact of the congestion in the network in response to applying the policy.

50. The apparatus of claim 49, wherein the memory and computer program code are configured to, with the processor, cause the apparatus to:
discontinue the applying of the policy in response to receipt of an indication of a selection by the user to overrule the policy.

51. The apparatus of claim 42, wherein the memory and computer program code are configured to, with the processor, cause the apparatus to:
apply the congestion policy by triggering scanning of availability of one or more alternate cells or access points to access the network.

52. The apparatus of claim 42, wherein the memory and computer program code are configured to, with the processor, cause the apparatus to:
downgrade a quality of service request by restricting at least one guaranteed bit rate request for one or more bearers in response to the applying of the policy.

53. The apparatus of claim 42, wherein the memory and computer program code are configured to, with the processor, cause the apparatus to:
select a lower bit rate coding scheme corresponding to one or more applications utilizing adaptive coding in response to the applying of the policy.

54. The apparatus of claim 42, wherein the memory and computer program code are configured to, with the processor, cause the apparatus to:
apply policy by enabling acceptance of one or more requests to access the network even though the detecting indicates that the network is congested.

55. A computer program product comprising at least one non-transitory computer-readable storage medium having computer-readable program code portions stored therein, the computer-readable program code portions comprising:
program code instructions configured to analyze data of at least one policy, the data of the policy comprising information instructing one or more communication devices regarding a manner in which to behave according to one or more designated network conditions as designated by a network operator;
program code instructions configured to apply the policy in response to detecting that a load of a network is increased or that the network is congested; and
program code instructions configured to enable behavior in the manner designated by the network operator according to the applied policy in response to detecting the increased load or that the network is congested to minimize a congestion in the network.
